(19) United States
(12) Patent Application Publication
(10) Pub. No.: US 2013/0000420 A1
(43) Pub. Date: Jan. 3, 2013

(54) ULTRASONIC MERGING OF PARTICLES IN MICROWELLS

(75) Inventors: Otto Manneberg, Taby (SE); Martin Wiklund, Stockholm (SE); Björn Önfelt, Bromma (SE); Thomas Frisk, Ingaro (SE); Hans M. Hertz, Stocksund (SE); Bruno Vanherberghen, Enskede (SE)

(73) Assignee: Jettec AB, Stocksund (SE)

(21) Appl. No.: 13/512,092

(22) PCT Filed: Nov. 26, 2010
(86) PCT No.: PCT/EP10/68313

§ 371 Date: Sep. 4, 2012

(30) Foreign Application Priority Data
Nov. 27, 2009 (SE) 0950907-6

(51) Int. Cl. G01N 1/28

(52) U.S. Cl. 73/863

(57) ABSTRACT

A method for simultaneously merging suspended particles and/or cells in a plurality of discrete microwells, each of said microwells having at least a bottom wall and lateral walls, wherein a multifrequency or broadband acoustic wave including at least two different frequencies is applied to an inner volume of each of said microwells, the frequencies of said acoustic wave being selected to generate a standing and/or stationary wave in said volume; a device for simultaneously merging suspended particles and/or cells in a plurality of discrete microwells, including: a substrate with a plurality of discrete microwells, each of said microwells having at least a bottom wall and lateral walls; and one or more acoustic transducer(s), configured for applying a multifrequency or broadband acoustic wave, including at least two different frequencies, to an inner volume of each of said microwells.

### FIELD OF THE INVENTION

The present invention relates to a method and device for simultaneously merging suspended particles and/or cells in a plurality of discrete microwells, each of said microwells having at least a bottom wall and lateral walls, wherein said merging is achieved by applying an acoustic wave to an inner volume of each of said microwells, a frequency of said acoustic wave being selected to generate a standing and/or stationary wave in said volume.

### BACKGROUND

Ultrasound-assisted manipulation, e.g. merging, positioning, guiding or separation, of particles and cells, has attracted attention during the last few years as an aid in studying the interaction of individual cells or aggregates of cells.

Ultrasound-assisted merging of cells provides for temporal control of cell-cell and cell-particle interactions, and for positioning, retaining and stabilizing aggregates of cells and/or particles. Ultrasound-assisted merging may thereby significantly reduce the analysis times for studies of cell-cell and cell-particle interactions compared with conventional probability-based coincidence.

However, the use of ultrasound-assisted manipulation in, for example, studies of single cells or cell aggregates has proven to be difficult in practical applications where examination of large numbers of individual cells or cell aggregates is often required for drawing statistically and scientifically relevant conclusions.

Multi-well plates, such as microtiter plates (or microplates/microwell plates) are often used for studies of cell heterogeneity and cell dynamics in large populations by variation of experimental conditions and parameters, e.g. concentrations, cell types or drugs. Multi-well plates facilitate parallelization and automation of analytical methods and advantages include increased throughput and reduced analysis time, reagent volumes and costs, etc. Standard formats of multi-well plates include 96- and 384-well plates, but microtiter plates ranging from 6 to more than 3456 wells are commercially available.

Devices hitherto provided for ultrasound-assisted studies of multiple single cells or cell aggregates have either been overly complex, rendering them expensive and/or difficult to handle, or produced manipulation results that are insufficient for the purposes of cell interaction studies.

Several attempts have been made to produce arrays of cell aggregates within a single chamber using interference patterns formed by acoustic waves travelling in different directions. One such attempt is described in “T. Lilliehorn et al., Ultrasonics, 43, (2005), 293-303”, another attempt is described in “Oberti et al., J. Acoust. Soc. Am., Vol. 121, No. 2, February 2007”. However, such arrays of cell aggregates within a single chamber are of limited use in studies of cell-cell interactions since the fact that all cells are present inside the same single chamber, and thus within the same volume of fluid, does not allow the independent study of each single cell or cell aggregate. Furthermore, when the ultrasound is switched off the cells within the single chamber will mix, making it difficult or impossible to follow individual cells to be studied.

Other attempts have been made to produce devices for merging or positioning single cells or cell aggregates present inside a single chamber. Such devices have produced good manipulation results for single wells but it has been found that it is difficult to scale up these devices to provide devices in which merging or positioning of cells can be performed simultaneously in a plurality of discrete chambers. Generally, although merging or positioning may be obtained in one or possibly a few adjacent chambers in such a device, most chambers will not exhibit sufficient merging or positioning.

Thus, there is still a need for improved tools for high throughput studies of single cells and cell aggregates in general, and for improved tools for parallelized merging of cells and particles in multi-well plates in particular.

### SUMMARY OF THE INVENTION

It is an object of the present invention to provide an improved method and a device for simultaneously merging and /or positioning particles and/or cells in a plurality of discrete microwells.

This object, as well as other objects that will be apparent from the present disclosure, is achieved by a method or a device according to the different aspects illustrated herein.

According to one aspect illustrated herein, there is provided a method for simultaneously merging suspended particles and/or cells in a plurality of discrete microwells, each of said microwells having at least a bottom wall and lateral walls,

wherein a multifrequency or broadband acoustic wave comprising at least two different frequencies is applied to an inner volume of each of said microwells, the frequencies of said acoustic wave being selected to generate a standing and/or stationary wave in said volume.

According to another aspect illustrated herein, there is provided a device for simultaneously merging suspended particles and/or cells in a plurality of discrete microwells, comprising:

a substrate with a plurality of discrete microwells, each of said microwells having at least a bottom wall and lateral walls; and

one or more acoustic transducer(s), configured for applying a multifrequency or broadband acoustic wave, comprising at least two different frequencies, to an inner volume of each of said microwells.

According to yet another aspect illustrated herein, there is provided the use of an acoustic transducer emitting a multifrequency or broadband acoustic wave comprising at least two different frequencies for simultaneously merging suspended particles and/or cells in a plurality of microwells.

The term “particles and/or cells”, also referred to herein simply as “particles”, is intended to be interpreted broadly as encompassing all types of minute entities, living or dead, organic or inorganic, natural or synthetic, simple or complex, single particles or aggregates, or combinations thereof, having a size in the range of about 10 nm to about 1 mm. Examples of such minute entities include, but are not limited to, organic or inorganic particles, such as functionalized or non-functionalized polymer or metal particles, bubbles, droplets, prokaryotic cells such as plant cells, or eukaryotic cells, such as human or animal cells, viruses, large molecules or molecular complexes, such as DNA molecules or antibodies.

The term “manipulation”, as used herein, generally refers to all kinds of controllable external influence on the particles which cause a defined movement or holding of the particles or cells which would not occur without this external influence. Examples of such manipulation are merging, positioning, guiding or separating particles or cells in a microwell.

The term “merging”, as used herein, generally refers a type of manipulation wherein suspended particles and/or cells present in an inner volume of a microwell are merged together into a smaller partial volume inside said inner volume. The smaller partial volume may have different shapes depending on how the merging is brought about. For example, the merging may result the collection of the suspended particles and/or cells in a stretched out shape, e.g. along a hypothetical line, curve, plane or curved plane, or it may result the collection of the suspended particles and/or cells in or around a specific point. Generally, it is preferable that the suspended particles and/or cells are collected in or around a specific point, since this facilitates monitoring of the formed aggregate by for example confocal microscopy.

The term “successful merging” , as used herein, generally refers to merging, wherein all or at least a majority of suspended particles and/or cells present in an inner volume of a microwell are collected in the smaller partial volume inside said inner volume. Successful merging further indicates that the suspended particles and/or cells are collected in or around a specific point in space.

When a single-frequency acoustic wave, formed e.g. by feeding an acoustic transducer with a single frequency driving voltage, is applied simultaneously to a plurality of microwells, successful merging may be obtained in one or possibly a few adjacent chambers in such a device, while most chambers will not exhibit successful merging.

The present invention is based on the inventive realization that successful merging and/or positioning of suspended particles and/or cells can be achieved simultaneously in a plurality of discrete microwells by applying to an inner volume of each of said microwells an acoustic wave composed of several, at least two, frequencies. Such a multi-frequency or broadband acoustic wave can be generated by feeding at least one acoustic transducer, with a driving voltage comprising at least two discrete driving frequencies or a broadband frequency range, or by feeding each of two or more acoustic transducers, with a driving voltage comprising at least one driving frequency. This allows for the provision of relatively simple and low cost devices for high throughput studies of for example cell-cell interactions.

The present method and device described herein may for example be used for studying cells and/or particles, or for providing and/or studying interactions between cells and/or particles. Specific examples of applications wherein the present method and device may be useful include, but are not limited to:
Providing a platform for cell-cell-interaction-based applications, e.g. involving cells of the immune system.
Activation or differentiation of cells (for example stem cells or immune cells) by triggering a surface response. The trigger could be a functionalized bead or another cell (co-cultures).
Merging of cells, e.g. B cells and myeloma tumor cells, to create hybridomas for production of monoclonal antibodies.
Producing cell “spheroids” for mimicking tissue in micro-scale.
Providing a platform for screening cells (individual or groups) or explanted tumors in drug discovery or optimization of drug protocols.

The above application examples are merely intended to illustrate the usefulness of the inventive method and device described herein in a range of practical situations, and are not intended to limit the scope of the invention in any way.

The merging of particles and/or cells in the microwells is based on the formation of a standing and/or stationary acoustic wave inside the inner volume of said microwells. The generation of a standing and/or stationary wave in the microwells generally depends on a relationship between the frequency or frequencies (wavelength(s)) of the acoustic wave and the geometric dimensions of the microwells. The presence of a standing and/or stationary acoustic wave in the microwell causes suspended particles present in the microwell to merge towards a node, i.e. a location of zero or insignificant acoustic radiation forces, of said standing and/or stationary wave. The present inventors have found that this effect may be significantly enhanced by employing a multifrequency or broadband acoustic wave, i.e. an acoustic wave composed by at least two (and often by many) different frequencies.

The method and device of the different aspects illustrated herein are based on merging of suspended particles and/or cells in microwells by applying an multifrequency or broadband acoustic wave comprising at least two different frequencies to an inner volume of each of said microwells. The merging of particles and/or cells in the microwells is based on the formation of a standing and/or stationary wave inside the inner volume of said microwells. The acoustic wave comprising at least two different frequencies is formed by feeding an acoustic transducer, with a least one driving voltage comprising at least two discrete driving frequencies or a broadband frequency range, or by feeding each of two or more acoustic transducers, with a driving voltage comprising at least one driving frequency. Each driving frequency of a driving voltage fed to an acoustic transducer results in the emission of an acoustic wave comprising at least one frequency. The frequencies of the acoustic wave produced by an acoustic transducer may be varied by varying the driving frequency of the driving voltage fed to the transducer.

The at least two driving frequencies should preferably be selected to generate a standing and/or stationary wave inside the inner volume of the microwells. Suitable frequencies for generating a standing and/or stationary wave inside the inner volume of the microwells will vary depending on a wide range of parameters. Suitable driving frequencies for a specific device may be readily determined by a person skilled in the art by tuning the respective frequencies and observing the behavior of cells and/or particles in the microwells.

Suitable frequencies of the acoustic wave are typically frequencies in the ultrasound frequency range. More particularly, the frequencies may preferably be selected in the frequency range of 0.1-1000 MHz. A standing and/or stationary wave may for example be generated by providing a relationship between a microwell dimension and a frequency and wavelength of the acoustic wave such that the microwell walls may act as a resonating cavity for the acoustic wave. Preferably, the microwells should have a distance between two opposing inner walls which approximately matches either a multiple of half the acoustic wavelength, or an odd multiple of a quarter of the acoustic wavelength at a specific driving frequency. As an example, in a device wherein the microwells have a distance between two opposing inner walls of about 300 μm, a frequency close to 2.5 MHz may be employed to produce a half-wave standing and/or stationary wave in a water-based inner volume of the microwells.

The present method and device is not limited to the generation of standing and/or stationary acoustic wave(s) by using the microwell as a resonating cavity. It is also possible to generate a standing and/or stationary wave by interference of two acoustic waves travelling in different directions in the microwell, e.g. by interference of two acoustic waves applied by two or more acoustic transducers.

The method and device described herein involve applying a multifrequency or broadband acoustic wave to a plurality of discrete microwells simultaneously. The microwells used in the present method and device have at least a bottom wall and lateral walls, optionally also a top wall, and are integrated in a substrate, also called chip, having a top and a bottom surface. The top and the bottom surface of the substrate represent the surfaces with the largest area of such a substrate, the top and bottom being related to the orientation of the substrate during the intended use. The outer surfaces of the optional top wall and the bottom wall of the microwells form part of the top and bottom surface of the substrate as is known in the art. The microwells may be formed in any suitable substrate material, including silicon, glass, metals or polymeric materials. Preferred materials include materials suitable for propagating an acoustic wave and/or suitable for hosting an acoustic resonance, such as for example silica, glass or metal. The bottom and/or optional top walls may be formed of the same or a different material than the substrate material. The bottom and/or optional top walls of the microwell may be formed of an optically transparent material, such that visual inspection, e.g. optical microscopy, of the contents of the microwell is possible.

Each microwell comprises an inner volume configured to hold a sample fluid during operation of the device. The inner volume may preferably be the entire inner volume of the microwell, but it may also be a partial volume of the microwell, e.g. a bottom portion.

In an embodiment wherein the formation of a standing and/or stationary wave is based on the microwells serving as resonating cavities for an acoustic wave, the dimensions of the microwells may preferably be selected to approximately match either a multiple of half the acoustic wavelength, or an odd multiple of a quarter of the acoustic wavelength at a specific driving frequency. For frequencies in the range of 0.1-1000 MHz, which may generally be suitable for particle merging in the present method, the microwells may preferably be designed to have a distance between two opposing inner walls in a range of 0.5 μm to 10 mm, preferably in a range of 10 μm to 1 mm, such as in a range of 50 μm to 500 μm.

The microwells generally define an inner volume which may be fitted within a hypothetical cuboid having dimensions in a range of 0.5 μm to 10 mm (width)×0.5 μm to 10 mm (breadth)×0.5 μm to 10 mm (depth), preferably in a range of 10 μm to 1 mm (width)×10 μm to 1 mm (breadth)×10 μm to 1 mm (depth), such as in a range of 50 μm to 1 mm (width)×50 μm to 1 mm (breadth)×50 μm to 1 mm (depth). Deeper wells are also possible, e.g. wells having a depth in a range of 1-20 mm, but wherein an inner volume configured to hold a sample fluid during operation may be fitted within a hypothetical cuboid having dimensions in a range of 0.5 μm to 10 mm (width)×0.5 μm to 10 mm (breadth)×0.5 μm to 10 mm (depth). Typical dimensions of the microwells are, for example, cuboid geometry, 300 μm×300 μm wide and 500 μm deep.

The different aspects illustrated herein allows successful merging and/or positioning of suspended particles and/or cells simultaneously in a plurality of microwells. In embodiments, the plurality of discrete microwells comprises at least 6 or more discrete microwells, such as for example 24 or more, 96 or more, 384 or more, or 1536 or more discrete microwells. The plurality of discrete microwells may generally comprise less than 9600 discrete microwells, such as for example less than 3456 discrete microwells.

The microwells used in the present method and device are discrete. In the present patent application the term “discrete” is used to describe that the inner volume of each microwell is separate from the inner volume of other microwells of the same substrate. Accordingly, a volume of liquid placed inside the inner volume of one microwell is separated from contact with volumes of liquid placed inside the inner volumes of other microwells. This arrangement allows the cells and/or particles of each microwell to be studied, analyzed and/or modified independently of cells and/or particles of other microwells of the same substrate. It also allows the merging to be switched off without any risk of cells, particles or aggregates thereof becoming mixed up.

The acoustic wave is generally generated by applying a driving voltage to an acoustic transducer. The driving voltage may comprise one or more discrete driving frequencies or a broadband frequency range.

According to an embodiment, the multifrequency or broadband acoustic wave is generated by feeding at least one acoustic transducer, with a driving voltage comprising at least two discrete driving frequencies, or by feeding each of two or more acoustic transducers, with a driving voltage comprising at least one driving frequency. In other words, the multifrequency or broadband acoustic wave can be generated by feeding a driving voltage comprising at least two driving frequencies to the same transducer, or by feeding each of two or more transducers with single frequency driving voltages having different frequencies.

According to an embodiment, the acoustic wave is generated by feeding an acoustic transducer with a driving voltage comprising at least two discrete driving frequencies.

In an embodiment, wherein the acoustic wave is generated by feeding an acoustic transducer with a driving voltage comprising at least two discrete driving frequencies, driving voltage may comprise said two discrete driving frequencies sequentially. In other words, the frequency of the driving voltage is alternated between the at least two discrete driving frequencies.

In an embodiment, wherein the acoustic wave is generated by feeding each of two or more acoustic transducers, with a driving voltage comprising at least one driving frequency, the driving voltages may be applied sequentially by alternately applying a first driving voltage with a first driving frequency to a first acoustic transducer and a second driving voltage with a second driving frequency to a second acoustic transducer.

In an embodiment, wherein at least two driving frequencies are applied sequentially to the transducer(s), the application of the at least two driving frequencies may be cycled, such that a sequence of driving frequencies is applied repeatedly at a suitable rate. The sequence may for example be cycled at a rate of 0.1-10000 Hz.

The sequential application of the at least two driving frequencies may be achieved by sweeping the frequency of the driving voltage in a suitable range. This type of sequential application of driving frequencies is referred to herein as frequency modulation.

In an embodiment, the a frequency of said driving voltage is modulated to produce at least two discrete driving frequencies.

Modulation of the frequency represents a form of sequential application of driving frequencies, wherein a frequency of a driving voltage is swept continuously over a range of frequencies. In a preferred embodiment, sequential application of the at least two driving frequencies may be achieved by modulating the driving frequency of a driving voltage applied to an acoustic transducer. Modulation of the frequency in the present patent application refers to a variation of the frequency of a driving voltage around a frequency resulting in the formation of a standing and/or stationary wave in an inner volume of a microwell. Modulation of the driving frequency can be performed in many different ways as readily recognized by a person skilled in the art.

In an embodiment the frequency modulation comprises a frequency sweep between a first frequency value which is equal to or higher than a frequency selected to generate a standing and/or stationary wave in said volume, and a second frequency value which is equal to or lower than said frequency selected to generate a standing and/or stationary wave in said volume. Modulation of the driving frequency generally refers to a variation of the driving frequency in a range of about ±100%, preferably in a range of about ±20%, more preferably in a range of about ±10%, of a frequency selected to generate a standing and/or stationary wave. Thus, in an embodiment, the frequency modulation comprises a frequency sweep between a first frequency value selected in a range of 0-100%, preferably in a range of 80-100%, more preferably in a range of 90-100%, of a frequency selected to generate a standing and/or stationary wave in said volume, and a second frequency value selected in a range of 100-200%, preferably in a range of 100-120%, more preferably in a range of 100-110%, of said frequency selected to generate a standing and/or stationary wave in said volume.

In an embodiment, wherein the at least two driving frequencies are applied by modulating the frequency of a driving voltage, the application of the frequency sweep may be cycled, such that the frequency sweep is applied repeatedly at a suitable rate. The frequency sweep may for example be cycled at a rate of 0.1-10000 Hz. A suitable frequency modulation scheme, depending, e.g., on a driving frequency selected for generating a standing and/or stationary wave, the dimensions of the microwells, and the size of the particles or cells to be merged in the microwell, may be readily determined by a person skilled in the art in view of the example provided herein. For example, in an embodiment wherein a driving frequency of about 2.5 MHz is applied to generate a standing and/or stationary wave in the inner volumes of the microwells, a suitable frequency modulation scheme may include a saw-tooth frequency sweep cycled with a rate of 1000 Hz with 2.5 MHz as the center frequency and a bandwidth of 100 kHz.

According to an embodiment, the multifrequency or broadband acoustic wave is generated by feeding a first acoustic transducer with a first driving voltage comprising a first single driving frequency, and feeding a second acoustic transducer with a second driving voltage comprising a second single driving frequency, which is different from said first single driving frequency.

In an embodiment, said first and second driving voltages may preferably be fed simultaneously to the transducers. Each transducer is preferably arranged to apply an acoustic wave generated by the transducer to an inner volume of each of the microwells. When at least two driving voltages having different driving frequencies are applied simultaneously to different transducers, the difference in frequency between the two driving voltages may preferably be such that the higher frequency is in a range of 1+10⁻⁶ to 20 times higher than the lower frequency, such as for example in a range of 0.01-5 times higher than the lower frequency. The frequencies are generally in a range of 0.1-1000 MHz, preferably in a range of 1 to 10 MHz. As an example, when the lower frequency is about 2.5 MHz, the higher frequency may be about 7 MHz.

The acoustic transducer can be any kind of transducer which is able to convert a driving voltage to an acoustic wave, for example a piezoelectric transducer. An example of such a transducer is a piezoceramic plate, for example of PZT, which is able to emit acoustic waves in the required frequency range, which is generally in the range of 0.1-1000 MHz.

The acoustic transducer may be activated by applying a suitable driving voltage to the transducer. When the acoustic transducer is activated by a suitable driving voltage, an acoustic wave is produced by the transducer. The frequency or frequencies of the acoustic wave may be varied by varying the frequency or frequencies of the applied driving voltage. Suitable driving voltages for specific transducers and devices may be determined by a person skilled in the art and may for example be in a range of 1-10 V (peak-to-peak).

Although the acoustic waves generated by the acoustic transducer(s) may be applied directly from the transducer(s) to an inner volume of said microwells, it is generally advantageous to forward the acoustic waves from the acoustic transducer(s) to the inner volume of said microwells via the substrate. When the acoustic waves are forwarded to the inner volume of the microwells via the substrate, the positioning of the acoustic transducer becomes less important. Instead, the frequencies or combinations of frequencies suitable for the formation of a standing and/or stationary wave inside the inner volume of said microwells are determined by the geometry and dimensions of the microwells. Essentially, the transducer may be placed anywhere on the device as long as the acoustic waves can be propagated into the substrate material.

Thus, in an embodiment the at least one acoustic transducer is arranged in contact with the substrate, such that acoustic waves emitted by the acoustic transducer can be propagated into the substrate.

Preferably the acoustic transducer is arranged outside of a straight optical path through an optional top wall, said inner volume and said bottom wall. In one embodiment of such a device, the top wall and the bottom wall of the microwell are thin enough to allow optical transmission microscopy with a high numerical aperture for observing particles and/or cells in said microwell.

The observation is possible since the acoustic transducer(s) are arranged outside of the straight optical path needed for optical transmission microscopy.

Although the method and device described herein may also be operated with two or more acoustic transducers, in an advantageous embodiment, the method and device may be operated with a single acoustic transducer. Using a single transducer reduces the complexity and cost of the device, which are important parameters in devices for high throughput screening.

Further objects, features and advantages of the present invention will be apparent from the description and the claims. The above described and other features are exemplified by the following figures and detailed description.

### BRIEF DESCRIPTION OF THE DRAWINGS

Many aspects of the invention can be better understood with reference to the following drawings. The figures are exemplary embodiments, wherein the like elements are numbered alike.

FIG. 1 is a schematic side view of a cross section of the device (FIG. 1a) and a schematic top view of the device (FIG. 1b).

FIG. 2 is a schematic top view of an embodiment of the device having a transducer with a large base area (FIG. 2a), an embodiment of the device having two transducers (FIG. 2b), and an embodiment of the device having four transducers (FIG. 2c).

FIG. 3 is a schematic top view of the arrangement of microwells (FIG. 3a) and a schematic top view of different microwell geometries (FIG. 3b).

FIG. 4 is a schematic side view of a cross section of an embodiment of the device.

FIG. 5 represents microscopic images of particle merging in a) a device using a single driving frequency and b) using a modulated driving frequency.

### DETAILED DESCRIPTION

Hereinbelow, various embodiments of the invention will be described in detail with reference to the drawings.

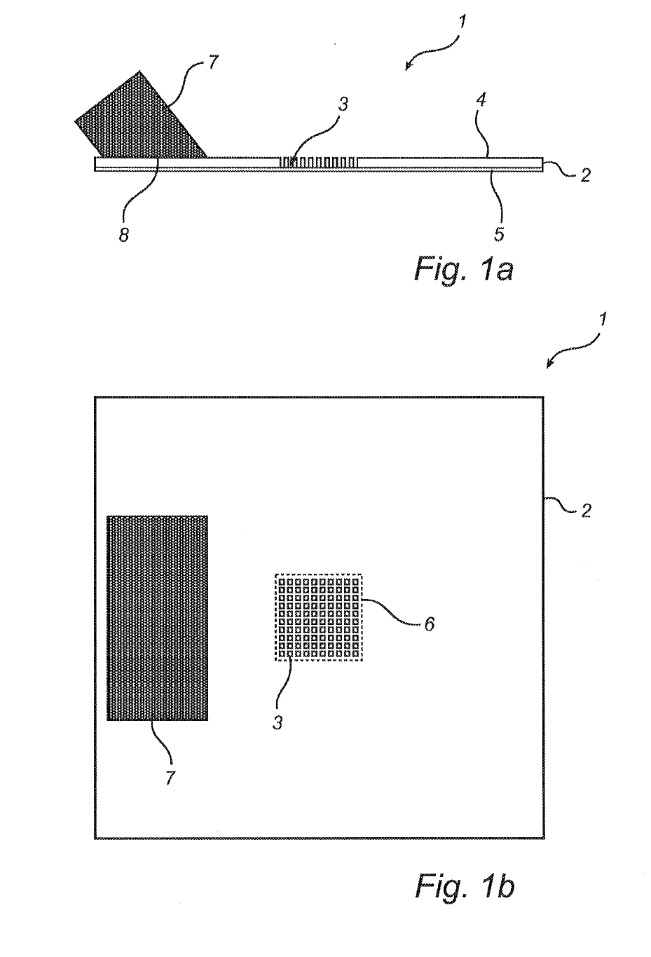

Referring to an embodiment of the device shown in FIGS. 1a and 1b, the device 1 comprises a substrate 2 having a plurality of microwells 3. The substrate comprises a silicon layer 4 (approximately 500 μm thick) which is bonded to a glass layer 5 (approximately 200 μm thick). In the silicon layer 4 100 microwells have been etched. Each microwell 3 is essentially quadratic, 300 μm by 300 μm, as seen from a top view. The microwells are located within a microwell area 6 on the substrate top surface. The microwells 3 are arranged in an even pattern consisting of 10 rows and 10 columns. The microwells are etched though the silicon layer 4, so as to form an open and optically transparent system wherein the bottom wall is formed by the glass layer 5.

The device further comprises an acoustic transducer 7. The acoustic transducer 7 comprises a piezoceramic plate, for example of PZT. The acoustic transducer may for example be a wedge transducer of the type described by Manneberg et al. in J. Micromech. Microeng., 18, (2008). The acoustic tranducer 7 is fixed to the substrate 2, e.g. by bonding or gluing, such that vibrations (acoustic waves) emitted by the transducer 7 are propagated into the substrate 2. In an alternative embodiment, the acoustic transducers can be maintained in contact with the substrate without gluing or bonding. The contact between the acoustic transducer and the substrate may instead be improved by application of a suitable non-adhesive coupling fluid (e.g. microscopy immersion oil) at the interface 8 between the contact surfaces.

The acoustic transducer preferably is connected to a suitable signal source (not shown). The signal source may for example be a suitable function or signal generator capable of frequency generation and modulation in the required frequency range.

During operation of a device as shown in FIG. 1, the transducer is fed with a suitable driving voltage comprising a modulated frequency of about 2.5 MHz from the signal source, such that an acoustic wave is generated by the transducer. The driving frequency of the driving voltage is modulated around the frequency of 2.5 MHz using a saw-tooth sweep cycled with a rate of 1000 Hz and a bandwidth of 100 kHz.

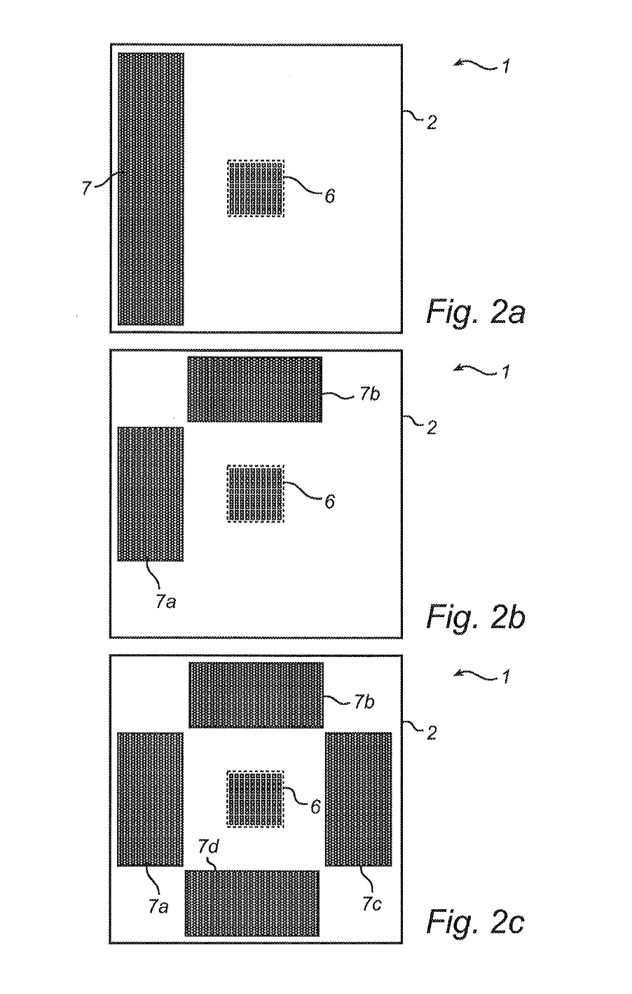

In an embodiment shown in FIG. 2a, the acoustic transducer 7 may preferably be configured to have a large base area adapted for contact with the substrate. The base area of the transducer may preferably be as large as possibly allowed by the substrate area since a larger contact area provides better and more evenly distributed propagation of the acoustic wave into the substrate. Preferably, the width of the base of the transducer in contact with the substrate may be larger than the longest distance across the microwell area 6. The width of the base of the transducer in contact with the substrate may preferably be about be about 50%, or more, larger than the longest distance across the microwell area.

Referring to FIGS. 2b and 2c, the device may comprise more than one acoustic transducer, such as two transducers 7a, 7b, or four transducers 7a, 7b, 7c, 7d. An advantage of having two or more transducers is that it allows several discrete frequencies to be applied simultaneously. Another advantage of embodiments having more than one transducer is that the device becomes less dependent on the selection of substrate material, microwell geometry and microwell dimensions. Even if the substrate material, microwell geometry and microwell dimensions is not selected to generate standing and/or stationary wave in the microwells when a single frequency is applied, a standing and/or stationary wave may still be generated by interference between the acoustic waves emitted by the different transducers.

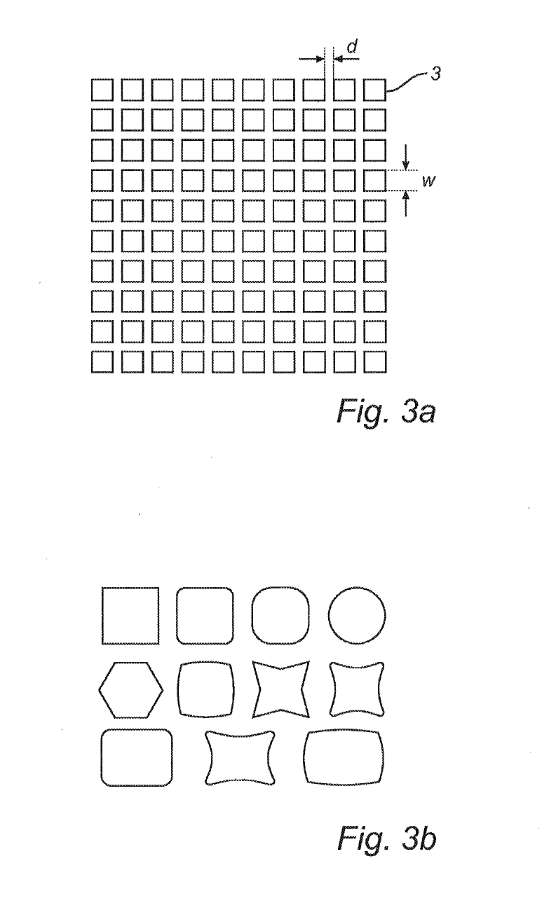

FIG. 3a schematically illustrates a possible microwell arrangement. The sides (w) of each microwell 3 is 300 μm and the walls separating the adjacent microwells are 100 μm thick (d).

FIG. 3b schematically illustrates a number of possible microwell geometries.

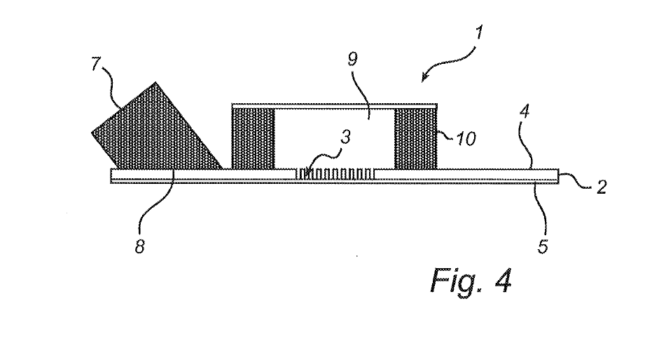

With reference to an embodiment shown in FIG. 4, the device may further comprise a sample handling system. In a simple embodiment, such a sample handling system may comprise an open fluid reservoir 9 created by placing a square-shaped PDMS (polydimethylsiloxane) frame 10 with inner width slightly wider than the microwell pattern. The PDMS frame 10 is configured to keep a desired sample volume in place over the microwells 3 and keeps the sample liquid separated from the acoustic transducer 7. A cover-slip-type glass lid 11 may be placed over the PDMS frame to prevent sample evaporation and/or contamination. The PDMS frame 10 and glass lid 11 allows for adding or removing sample fluid, fluorescent probes, signal factors, functionalized beads, fresh cell medium, new cells, etc., by manual pipetting in the open fluid reservoir above the microwells. Ultrasonic merging during handling of liquids in the fluid reservoir can be employed to reduce the risk of losing, disintegrating or de-positioning the aggregates.

The device may optionally further comprise a holder (not shown), wherein the substrate, acoustic transducer, sample handling system and microscope mounting frames are integrated in a single device.

The device is designed to be compatible with high-resolution optical microscopy (e.g. confocal fluorescent microscopy). This is done by having the chip transparent, and providing a glass bottom layer having cover-slip thickness (150-200 μm). The acoustic transducer is attached to an edge portion of the substrate, such that it does not obstruct a straight optical path through any one of the microwells.

Advantages of a method and device according to different aspects and embodiments of the invention include:
Provides successful merging of suspended particles and/or cells in a plurality of discrete microwells simultaneously.
Allows individual handling of cells/aggregates. Because each aggregate is arranged in an individual microwell it is possible to keep each aggregate separated from the other aggregates. This can reduce or eliminate cross-talk between aggregates compared to prior art 2D arrays
Allows the use of acoustic merging for simultaneous initiation of the of the cell-cell contact in a plurality of microwells, whereafter the acoustic transducer may be switched off and the continued interaction of individual cells and/or aggregates of cells can be monitored without the influence of acoustic merging. This feature provides a method which is more biocompatible compared to methods wherein the acoustic merging must be maintained over the entire course of the study.

While the invention has been described with reference to a number of preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

### Example

### Example 1—Single frequency vs. modulated frequency

In a device as described with reference to FIG. 4, a suspension comprising 5 μm polyamide beads was added to the sample reservoir. The particles were allowed to sediment down into the microwells such that similar quantities of the beads were collected in each of the microwells. When the beads had settled in the microwells, the acoustic transducer was activated.

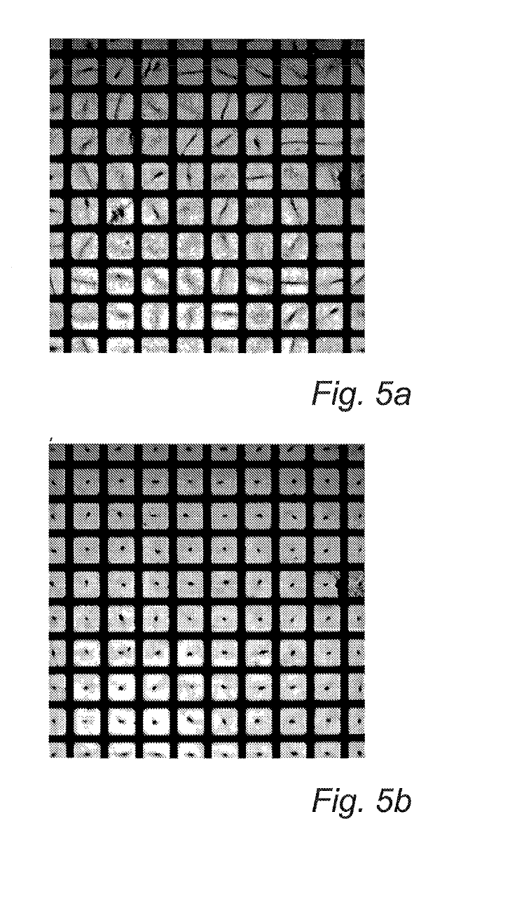

First, a driving voltage comprising a single driving frequency of about 2.5 MHz was applied to the substrate. This frequency was selected to generate a standing and/or stationary wave in at least some of the microwells of the substrate. As shown in FIG. 5a (microscope image), the application of a single driving frequency resulted in relatively poor merging of the beads in a majority of the microwells. The beads were concentrated into lines or curves with different orientations and different efficiency in the different wells, or essentially not concentrated at all.

Thereafter, the driving voltage comprising a single driving frequency was replaced by a driving voltage comprising a modulated driving frequency (saw-tooth frequency sweep at a rate of 1000 Hz with 2.5 MHz as the center frequency and a bandwidth of 100 kHz). The frequency modulation resulted in a significant improvement of the particle merging in the microwells as evident from FIG. 5b (microscope image). By employing a frequency-modulation scheme, the beads could be confined into small spots centered in each microwell with very uniform efficiency in all the microwells.

1. A method for simultaneously merging suspended particles and/or cells in a plurality of discrete microwells, each of said microwells having at least a bottom wall and lateral walls,
wherein a multifrequency or broadband acoustic wave comprising at least two different frequencies is applied to an inner volume of each of said microwells, the frequencies of said acoustic wave being selected to generate a standing and/or stationary wave in said volume.

2. A method according to claim 1, wherein said acoustic wave is generated by feeding at least one acoustic transducer, with a driving voltage comprising at least two discrete driving frequencies, or by feeding each of two or more acoustic transducers, with a driving voltage comprising at least one driving frequency.

3. A method according to claim 2, wherein said acoustic wave is generated by feeding an acoustic transducer, with a driving voltage comprising at least two discrete driving frequencies.

4. A method according to claim 3, wherein said driving voltage comprises said at least two discrete driving frequencies sequentially.

5. A method according to any one of claims 2 to 4, wherein a frequency of said driving voltage is modulated to produce at least two discrete driving frequencies.

6. A method according to claim 5, wherein said frequency modulation comprises a frequency sweep between a first frequency value which is equal to or higher than a frequency selected to generate a standing and/or stationary wave in said volume, and a second frequency value which is equal to or lower than said frequency selected to generate a standing and/or stationary wave in said volume.

7. A method according to claim 6, wherein said frequency modulation comprises a frequency sweep between a first frequency value selected in a range of 90 to 100% of a frequency selected to generate a standing and/or stationary wave in said volume, and a second frequency value selected in a range of 100 to 110% of said frequency selected to generate a standing and/or stationary wave in said volume.

8. A method according to any one of claims 6 to 7, wherein said frequency sweep is cycled at a rate of 0.1 to 10000 Hz.

9. A method according to claim 2, wherein said acoustic wave is generated by feeding a first acoustic transducer with a first driving voltage comprising a first single driving frequency, and feeding a second acoustic transducer with a second driving voltage comprising a second single driving frequency, which is different from said first single driving frequency.

10. A method according to claim 9, wherein said first and second driving voltages are fed simultaneously to the transducers.

11. A method according to any one of the preceding claims, wherein said plurality of discrete microwells comprises 96 or more microwells.

12. A device for simultaneously merging suspended particles and/or cells in a plurality of discrete microwells, comprising:
a substrate with a plurality of discrete microwells, each of said microwells having at least a bottom wall and lateral walls; and
one or more acoustic transducer(s), configured for applying a multifrequency or broadband acoustic wave, comprising at least two different frequencies, to an inner volume of each of said microwells.

13. A device according to claim 12, further comprising a signal source configured for feeding a driving voltage comprising at least two discrete driving frequencies to the transducer(s).

14. A device according to claim 13, wherein said signal source is configured for feeding a driving voltage comprising said at least two discrete driving frequencies sequentially.

15. A device according to any one of claims 13 to 14, wherein said signal source is configured for modulating a driving frequency of said driving voltage to produce said at least two discrete driving frequencies.

16. A device according to claim 12, comprising two or more acoustic transducers.

17. A device according to claim 16, wherein said signal source is configured for feeding a first driving voltage comprising a first single driving frequency, feeding a second acoustic transducer with a second driving voltage comprising a second single driving frequency, which is different from said first single driving frequency.

18. A device according to claim 17, wherein said signal source is configured for feeding said first and second driving voltages simultaneously to the transducers.

19. A device according to any one of claims 12 to 18, wherein said at least one acoustic transducer is arranged in direct or indirect contact with the substrate, such that acoustic waves emitted by the acoustic transducer are propagated into the substrate.

20. A device according to any one of claims 12 to 19, wherein each of said microwells has a distance between two opposing inner walls in a range of 10 μm to 1 mm.

21. A device according to any one of claims 12 to 20, wherein said plurality of discrete microwells comprises 96 or more microwells.

22. Use of an acoustic transducer emitting a multifrequency or broadband acoustic wave comprising at least two different frequencies for simultaneously merging suspended particles and/or cells in a plurality of microwells.
